(19) United States
(12) Patent Application Publication
(10) Pub. No.: US 2017/0028357 A1
(43) Pub. Date: Feb. 2, 2017

(54) PORTABLE DEVICE FOR THE AUTOMATION AND CALCULATION OF A NORMALIZED SILT DENSITY INDEX THAT IS INDEPENDENT OF THE FILTER HOLDER ASSEMBLY

(71) Applicant: Wesley Charles Byrne, Wayzata, MN (US)

(72) Inventor: Wesley Charles Byrne, Wayzata, MN (US)

(21) Appl. No.: 15/201,530

(22) Filed: Jul. 4, 2016

Related U.S. Application Data
(60) Provisional application No. 62/189,469, filed on Jul. 7, 2015.

(51) Int. Cl. B01D 65/10; C02F 1/00; G01N 11/04; C02F 1/44

(52) U.S. Cl. CPC B01D 65/10; C02F 1/44; C02F 1/008; G01N 11/04; C02F 2209/02; C02F 2209/40; C02F 2209/03; C02F 2209/10

(57) ABSTRACT

This invention is connected to the influent or effluent stream of an SDI filter holder assembly that might otherwise be applied in the manual measurement of the flow rates and times as required to calculate a silt density index. The invention is based on its ability to provide data collection external to the filter holder assembly in digitally measuring the flow rate and water temperature proceeding to or from the filter assembly and in automatically incorporating those readings into a microprocessor for calculating the silt density index and in normalizing the index value for the effects of variation in initial filter permeability and water temperature, and in minimizing the effect of increasing cake solids on the SDI value as related to the decreasing flow of water-borne solids to the filter surface. Furthermore, the portability of the invention is enhanced via its ability to directly operate a pressure boosting pump to assist in achieving the typical SDI test pressure of 30 psi, and this portability is further enhanced with its ability to be powered by a battery.

### FIELD OF THE INVENTION

The present invention relates to the automation of the silt density index measurement of the suspended solids concentration in water that also standardizes the calculated index for variation in water temperature and filter permeability, and reduces the dampening effect of high concentrations of suspended solids on the index results. More particularly, the device is portably applied to the influent or effluent stream of an independent filter holder assembly that is not part of the automation device, but what otherwise would require manual flow rate and time measurement in performing a silt density index measurement.

### CROSS REFERENCE TO RELATED APPLICATIONS

This application is a conversion from non-provisional application 62189469 filed Jul. 7, 2015 entitled “Device for automating a silt density index measurement of the suspended solids concentration in water that also standardizes calculated index results for variation in water temperature, filter permeability, and reduces dampening effect of high concentrations of suspended solids.”

### BACKGROUND

Silt density index (SDI) has become a standard measurement method for monitoring the concentration of suspended solids in the feed water of a membrane system, such as a reverse osmosis (RO) or nanofiltration (NF) system, in order to quantify the potential for RO or NF membrane fouling by those suspended solids. As compared to most other measurements of suspended solids, such as water turbidity, SDI results have been found to better correlate with the rate of RO or NF membrane fouling.

The SDI test procedure quantifies the decline in water flow rate through a 0.45 micron rated membrane filter over time, typically using a 47 mm diameter nitrocellulose disc filter. The inlet pressure to the filter is regulated at a set pressure, usually 30 psig. The time in seconds is measured for 500 mL of the sample water stream to permeate through the filter, and then repeating this measurement continuing flow through the filter for a total period of time of 5, 10, and 15 minutes. The change in filter permeability as related to the collection of solids on the filter disc is then quantified using the following calculation in determining the SDI₅ (the SDI value over a 5 minute test period), SDI₁₀ (the SDI value over a 10 minute test period), and the SDI₁₅ (the SDI value over a 15 minute test period).

$${SDI}_{T} = 100 \times \frac{1 - {t}_{o} / {t}_{F}}{T}$$

Where: tₒ is the initial measurement in seconds for 500 mL to permeate the filter
t_{F} is the latter measurement in seconds for 500 mL to permeate the filter
T is the time in minutes from the beginning of the tₒ measurement to the beginning measurement of t_{F}

In the ASTM procedure (ASTM D4189 - 07(2014)), the SDI_{T} is only valid if the value of tₒ is more than 25% of the value of t_{F}, in order to limit the effect of the filtered solids cake on the reduction of the rate of water-borne solids to the filter surface. The best representation of the SDI_{T} is then the value calculated from the longest time T while remaining within the ASTM guideline and while not being longer than 15 minutes.

Performing this test with a graduated cylinder and stopwatch is time consuming, a problem that is mostly eliminated with the automation of the flow rate measurement that is offered by this invention. It is a significant benefit of this device, but this benefit is not unique to the device. There are other automated SDI devices currently available. Rather, the unique nature of this invention is in its offering of independence and portability in its ability to be externally attached to the SDI filtration assembly in order to automate the process.

A traditional SDI measurement and calculation as previously described will result in SDI values that are imprecise because they do not compensate for three variables that affect the rate of solids deposition on the filter disc. For one, they do not compensate for the effect of water temperature. Colder water does not permeate the filter disc as well as warm water, which affects the rate at which the suspended solids in the water are brought to the filter surface. It is known that water temperature should not be allowed to change during the test period. But even when the measurements are performed with the same water temperature, the SDI results will be a function of water temperature due to the related difference in the filter's water permeability as then related to the rate at which suspended solids are brought to the filter surface during the test period.

The SDI calculation also does not take into account the effect of varying filter disc permeability as related to its specific porosity and thickness of its nitrocellulose membrane. It is known that the specific flow rate through the filter is dependent on the filter manufacturer, and will vary to a lesser extent between lots of filter discs from the same manufacturer. The method for acknowledging this issue in the ASTM procedure (ASTM D4189-07(2014)) is to note the filter disc manufacturer and lot number.

But similar to this issue is the effect of when the initial measurement of the 500 mL permeation is initially performed. If there is delay in this measurement, possibly as related to adjusting the pressure regulator for a 30 psig setting, or in removing air from the filter housing, will result in some amount of solids deposition that will slow the permeation throughout the test period. A lower SDI value would be obtained just as if the test was performed with a filter disc that had reduced permeability.

Thirdly, a high concentration of suspended solids in the source water will affect the SDI results. The faster rate of filter fouling results in a reduced water flow rate that also reduces the flow of suspended solids to the filter surface. While the ASTM method allows the ratio of tₒ to t_{F} to be as low as 0.25, this results in a dampening of the SDI results by as much as ⅓ as compared to if this ratio is limited to 0.5. The difference between SDI values for an extremely poor water source as compared to those for a very good water source is minimized.

Therefore, a need exists for a portable flow rate and temperature measurement device that includes a microprocessor that can be applied to existing filter holder assemblies otherwise used in manual SDI measurement, so as to automate the use of those SDI filter assemblies while also obtaining more precise and repeatable results as related to the normalization calculations performed by the microprocessor.

### BRIEF SUMMARY OF THE INVENTION

This invention is connected to the influent or effluent stream of an SDI filter holder assembly that might otherwise be applied in the manual measurement of the flow rates and times as required to calculate a silt density index. The invention is based on its ability to provide data collection external to the filter holder assembly in digitally measuring the flow rate and water temperature proceeding to or from the filter assembly and in automatically incorporating those readings into a microprocessor for calculating the silt density index and in normalizing the index value for the effects of variation in initial filter permeability and water temperature, and in minimizing the effect of increasing cake solids on the SDI value as related to the decreasing flow of water-borne solids to the filter surface. Furthermore, the portability of the invention is enhanced via its ability to directly operate a pressure boosting pump to assist in achieving the typical SDI test pressure of 30 psi, and this portability is further enhanced with its ability to be powered by a battery.

### BRIEF DESCRIPTION OF THE DRAWINGS

Some embodiments of the present invention are illustrated as an example and are not limited by the figures of the accompanying drawings, in which like references may indicate similar elements and in which:

FIG. 1—FIG. 1 illustrates how the invention 6 might connect to an external silt density index measuring device that might consist of an inlet water plumbing connection 11, pressure measurement gauge 10, pressure regulator 9, filter holder 8, and outlet plumbing connection 7 before the water exits the invention through a plumbing connection 12.

FIG. 2—FIG. 2 illustrates how the invention 6 would use a battery 16 to electrically power its optional pump motor 13 with its electrical wiring connection 15, and using an inlet water plumbing connection 14 before pressurizing the water entering the inlet water plumbing connection 11 that is attached to an external silt density index measuring device that might also consist of a pressure measurement gauge 10, pressure regulator 9, filter holder 8, and an outlet plumbing connection 7 before the water exits the invention through a plumbing connection 12.

FIG. 3—FIG. 3 depicts an exploded perspective view of one example of the sensor assembly of the invention that would include a flow rate sensor 4 and a temperature sensor 1 that might be plumbed together with a tee 2, an inlet plumbing connection 5 and an outlet connection 3 according to various embodiments of the present invention.

FIG. 4A—FIG. 4A depicts a view of the top part of an enclosure that would contain the sensor components, microprocessor, and related electrical components according to various embodiments described herein.

FIG. 4B—FIG. 4B depicts a view of the bottom part of an enclosure that would contain the sensor components, microprocessor, and related electrical components according to various embodiments described herein.

FIG. 5—FIG. 5 shows a top view of an enclosure that would contain the sensor components, microprocessor, and related electrical components according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The present disclosure is to be considered as an exemplification of the invention, and is not intended to limit the invention to the specific embodiments illustrated by the fixtures of description below.

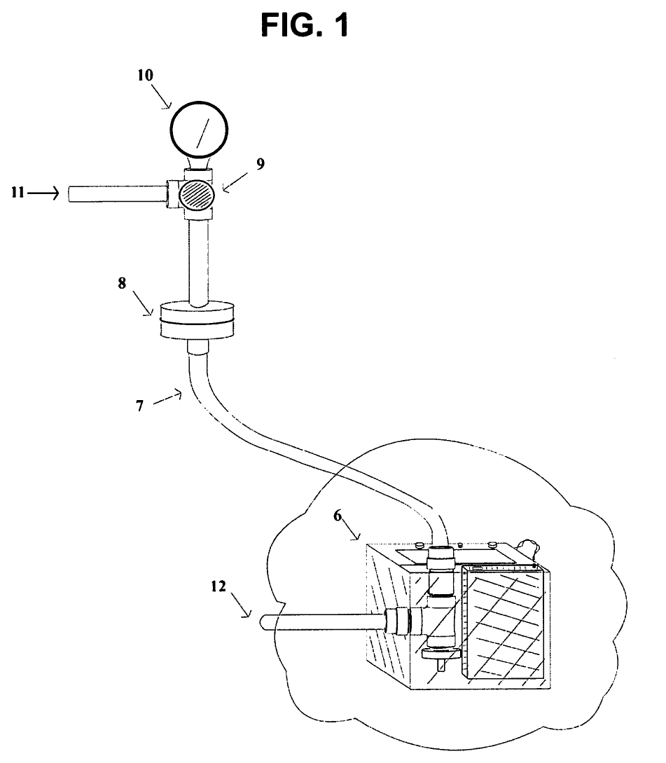

The present invention will now be described by referencing the appended figures representing preferred embodiments. FIG. 1 depicts a preferred embodiment of how the portable invention 6 would connect to either the influent or effluent plumbing 7 of one of possibly numerous silt density index (SDI) filter holder assemblies 8, 9, and 10 in order to automate the flow measurement and timing and to automatically calculate and normalize the SDI results.

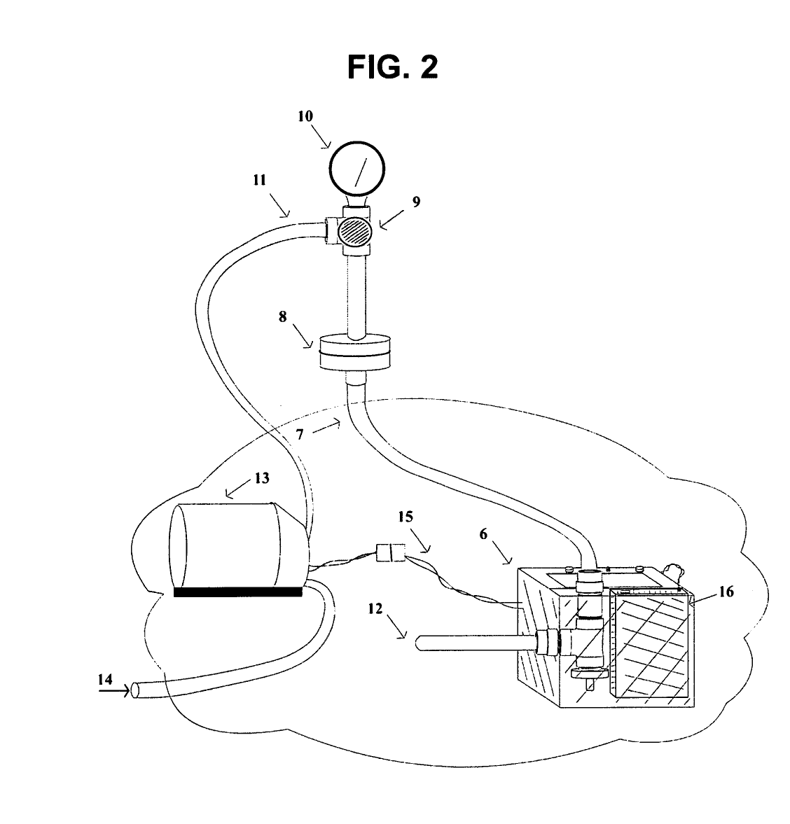

FIG. 2 illustrates another preferred embodiment of the invention in its ability to electrically power and control a pressure boost pump and motor via a battery. The pump motor operation would be controlled through an electrical connection with the microprocessor component of the invention. It should be understood that battery operation should be considered to be one operational way to power the portable invention, although it might also be powered using a transformer as inserted into a standard electrical outlet.

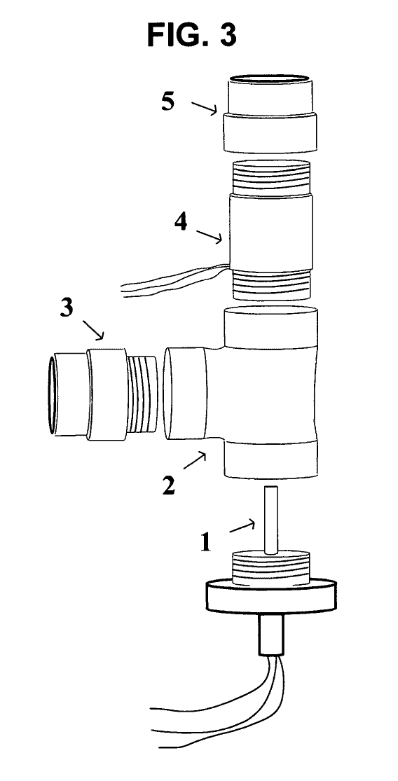

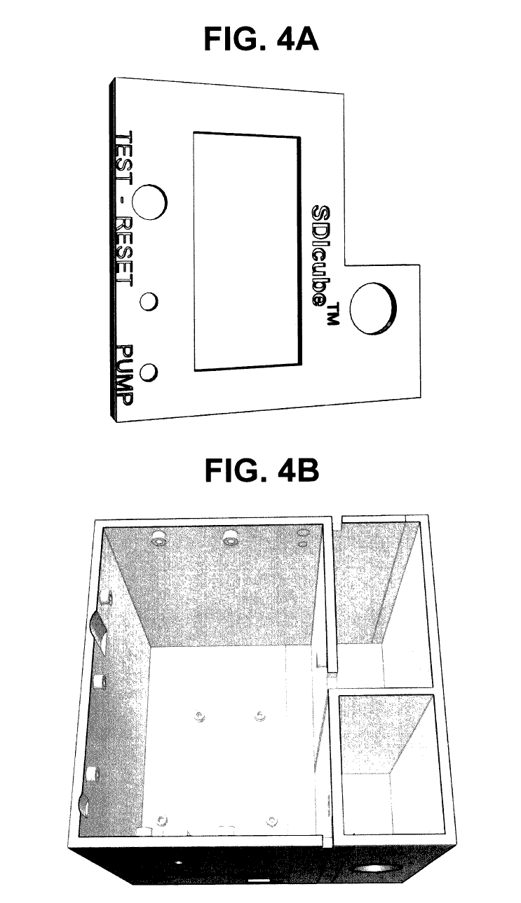

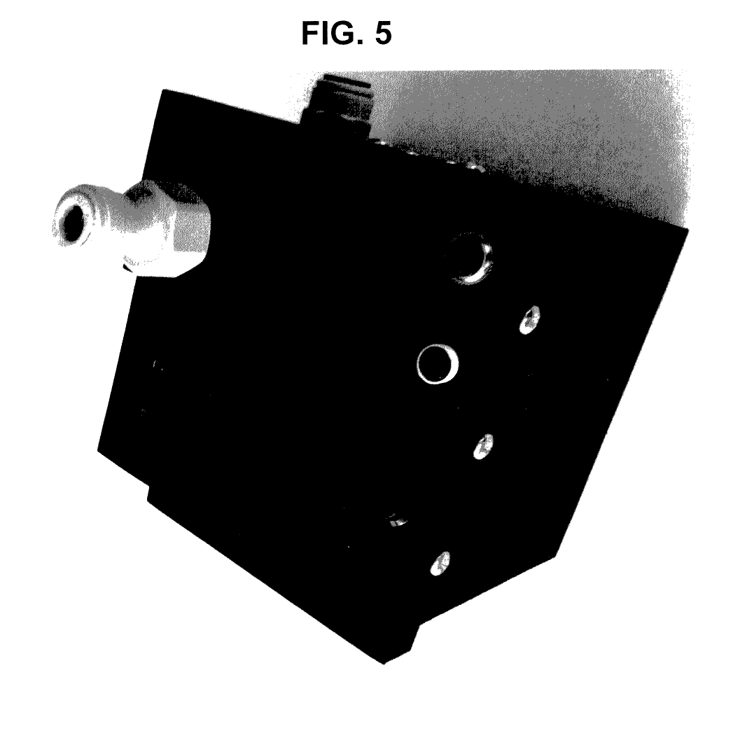

FIG. 3 depicts a preferred embodiment of the water flow rate and temperature sensor assembly that would be plumbed in some manner to the influent or effluent stream from the SDI filter holder assembly. These sensors would electrically provide their readings to a microprocessor for direct acquisition of the data necessary for calculating the silt density index and normalizing its value for the effects of variability in water temperature and in SDI test filter permeability.

After attaching the invention to an SDI filter holder assembly and after water is flowing through the devices, operation of the booster pump motor may be initiated from the invention, such as from a switch as one preferred embodiment of the invention. The SDI test is then initiated, such as via operation of another switch as a preferred embodiment of the invention. The test continues until it is complete either due to the water flow rate through the filter test assembly declining to half its initial value or because the test has proceeded to its maximum of 15 minutes at which point the test concludes with cessation of the pump motor and completion of the silt density index results and normalization calculations, which are displayed or transmitted by the invention.

What is claimed is:

1. A device that is connected to the influent or effluent plumbing of a silt density index membrane filter holder for the purpose of determining the change in water flow rate to or from the filter over time so as to electronically calculate a value for the silt density index of the influent water whereas the device is comprised of the following:
a. a water flow rate measurement sensor,
b. a water temperature sensor,
c. a microprocessor programmed to incorporate the water flow rate sensor measurements in calculating the silt density index while also normalizing this index for the effect of variation in the water flow rate to the filter surface as based on any difference in water temperature from a set temperature and on any difference in the initial water flow rate from a set water flow rate.

2. The invention of claim 1 wherein it can be physically moved for application between test filter assemblies to automate testing and normalize the results obtained in each location.

3. The invention in claim 1 wherein it can be powered using either an electrical battery or an electrical outlet power source.

4. The invention of claim 1 wherein it can provide operating electrical power for a pump or otherwise control the operation of a pump that increases the pressure of the water flowing to the filter.

5. The invention in claim 4 wherein it includes one or two water pressure sensors for measuring the pressure differential across the filter in order to more precisely normalize for the effect of variation in the pressure differential on the water flow rate to the filter surface.

6. The invention of claim 5 wherein it is capable of powering and controlling a pump motor to allow a specific volume of water to permeate the external filtration device as necessary for performing analyses of a controlled amount of filtered solids.
